(19) United States
(12) Patent Application Publication
(10) Pub. No.: US 2015/0127535 A1
(43) Pub. Date: May 7, 2015

(54) POSTING REAL-TIME PAYMENT CARD AUTHORIZATION PROCESS DATA TO SOCIAL MEDIA SITE

(71) Applicant: MASTERCARD INTERNATIONAL INCORPORATED, Purchase, NY (US)

(72) Inventors: Pedro J. CHAVARRIA, Hampton Bays, NY (US); David WEIS, Boerne, TX (US)

(73) Assignee: MASTERCARD INTERNATIONAL CORPORATION, Purchase, NY (US)

(21) Appl. No.: 14/071,441

(22) Filed: Nov. 4, 2013

(51) Int. Cl. G06Q 20/40; G06Q 20/34

(52) U.S. Cl. CPC G06Q 20/409; G06Q 20/34; G06Q 50/01
USPC 705/44

(57) ABSTRACT

A social media location posting system a payment card transaction authorization processor and a location posting service processor. The payment card transaction authorization processor is configured to receive over a network a payment card transaction authorization request for a cardholder and store in a computer storage file associated with the cardholder payment card transaction data included in the authorization request. The location service processor is configured to post over the network at least a portion the payment card transaction data stored in the file associated with the cardholder to a social media site associated with the cardholder.

### BACKGROUND

1. Field of the Disclosure

The present disclosure relates generally to the field of social media, and more particularly to systems, methods and computer program products that capture a cardholder's real-time payment card authorization process data and post the captured data to a social media site on behalf of the cardholder.

2. Description of the Related Art

Social media websites, such as Facebook®, have become widely used. Users can post photographs, articles of interest, statements about what is going on in their lives, and the like, for the benefit of their friends and acquaintances. Many people are very active social media users who may post information several times each day.

One popular social media feature is “check-in”, which enables users to post their location information in real-time. Typically, a user logs in to a social media site using a portable GPS-enabled device, such as a “smart phone.” The site determines the venue located at the user's location and posts that venue and the time of check-in to the users social media page. If the user has friends near the venue at the time of check-in, those friends may arrange to meet the user. Also, check-in can serve as a log of where the user has been, which the user can share with his or her friends.

Some social media users may not have a portable GPS-enabled devices. Accordingly, those users are unable to use check-in. However, such user may desire to be able to post to their social media pages automatically where they have been, thereby obtaining some of the advantages of check-in.

### SUMMARY

Embodiments include methods, systems, and computer-readable media that capture a cardholder's real-time payment card authorization process data and post the captured data to a social media site on behalf of the cardholder.

In one aspect, a method of posting payment card transaction information to a social media site includes receiving over a network at a payment card authorization processor a payment card transaction authorization request for a cardholder. The method stores, in a computer storage file associated with the cardholder, payment card transaction data included in the authorization request. The method posts at least a portion the payment card transaction data stored in the file associated with the cardholder to a social media site associated with the cardholder.

In another aspect, a social media location posting system includes a payment card transaction authorization processor that is configured to receive over a network a payment card transaction authorization request for a cardholder. The transaction authorization processor stores in a computer storage file associated with the cardholder payment card transaction data included in the authorization request. A location service processor is configured to post over the network at least a portion the payment card transaction data stored in the file associated with the cardholder to a social media site associated with the cardholder.

In another aspect, a non-transitory computer-readable storage medium is encoded with data and instructions, which when executed by a computing device the instructions causes the computing device to receive over a network a payment card transaction authorization request for a cardholder. The instructions, when executed, cause the computing device to store in a computer storage file associated with the cardholder payment card transaction data included in the authorization request. The instructions, when executed, cause the computing device to post over the network at least a portion the payment card transaction data stored in the file associated with the cardholder to a social media site associated with the cardholder.

### BRIEF DESCRIPTION OF THE DRAWINGS

The disclosure will best be understood by reference to the following detailed description of an illustrative embodiment when read in conjunction with the accompanying drawings, where:

FIG. 1 is a block diagram of an embodiment of a payment card authorization and social media site location posting system;

FIG. 2 is a pictorial representation of an embodiment of a payment card location service enrollment and sign-in webpage;

FIGS. 3A-3C are pictorial representations of embodiments of payment card location service enrollment information collection webpages;

FIG. 4 is a pictorial representation of an embodiment of a payment card location service merchant transaction item selection webpage;

FIG. 5 is a flowchart of an embodiment of payment card location service sign-in and enrollment processing;

FIGS. 6A and 6B comprise a flowchart of an embodiment of payment card location service enrollment processing;

FIG. 7 is a flowchart of an embodiment of payment card location service transaction information extraction processing;

FIG. 8 is a flowchart of an embodiment of transaction information selection and posting processing; and,

FIG. 9 is a block diagram of a computing device in which embodiments of the present disclosure may be implemented.

### DETAILED DESCRIPTION

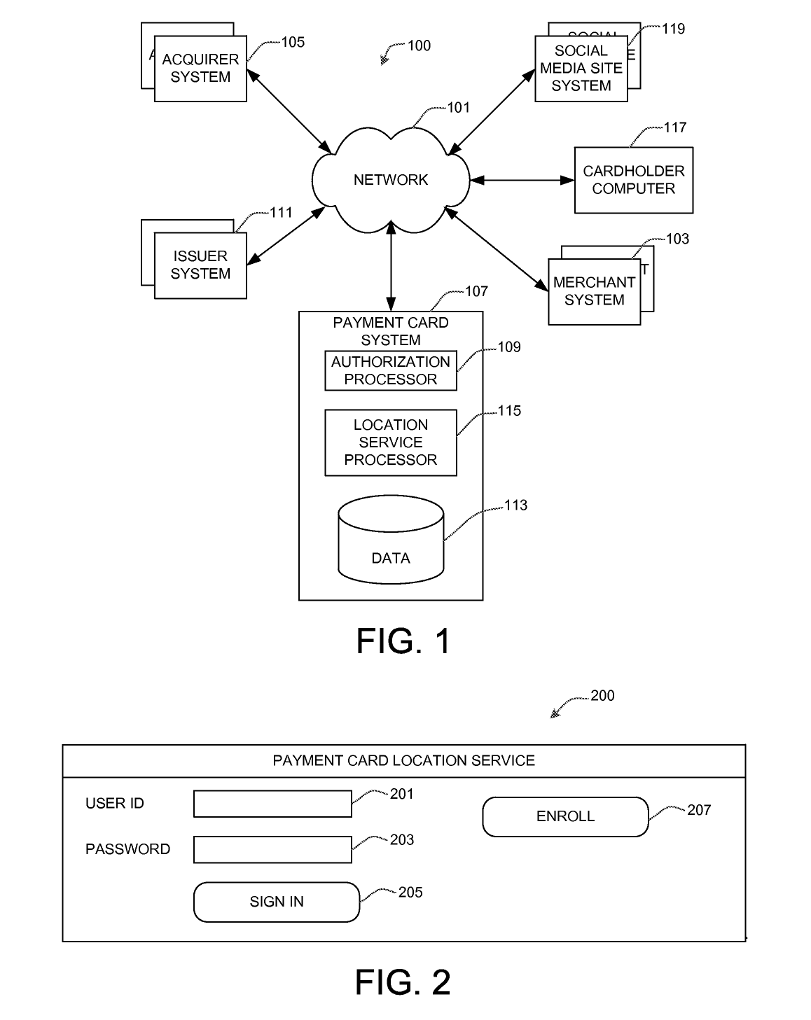

Referring now to the drawings, and first to FIG. 1, an embodiment of a payment card authorization and social media site location posting system is designated generally by the numeral 100. As used herein, a payment card is any credit card, debit card, or the like, that issued to a cardholder and that is used to purchase goods and/or services. System 100 includes a network, designated generally by the numeral 101. Network 101 can comprise one or more interconnected networks, such as the Internet.

A plurality of merchant systems 103 are connected to network 101. Merchant systems 103 include computing devices, such as point-of-sale terminals in “brick and mortar” retail establishments and computers or servers in online businesses. Each merchant system 103 collects payment card information from a cardholder in connection with a transaction. Payment card information includes a payment card account number and various security information.

The first step is payment card transaction processing is authorization, wherein a merchant system 103 determines whether or not a particular transaction will be honored. Merchant system 103 transmits an authorization request, which includes payment card and transaction information, over network 101 to one of a plurality of acquirer systems 105. An acquirer system 105 is a computer system at a financial institution, such as a bank, with which the merchant associated with merchant system 103 has an account. The transaction information includes the name and location of the merchant and the time, date and amount of the transaction.

Acquirer system 105 transmits the authorization request received from merchant system 103 over network 101 to a payment card network or system 107. Payment card system 107 includes an authorization processor 109, which is a computer or server that determines the issuer of the payment card identified in the authorization request. An issuer is a financial institution that issues payment cards to, and maintains accounts in the name of, cardholders. Authorization processor 109 transmits the authorization request over network 101 to an identified issuer system 111. As will be described in detail hereinafter authorization processor 109 also extracts from the authorization request real-time transaction information including the name and location of the merchant and the date and time of the authorization request, and stores the extracted information in a file associated with the cardholder in a data storage device 113.

The identified issuer system 111 authorization request and determines whether or not to authorize the transaction. In the case of debit card transactions, issuer system 111 determines, among other things, whether account associated with card has sufficient funds to cover the transaction. In the case of credit card transactions, issuer system 111 determines, among other things, whether the account associated with the card has sufficient credit to cover the transaction. Depending on the determination, issuer system 111 transmits to payment card system 107 an authorization response that authorizes or declines the transaction. Payment card system 107 forwards the authorization response to acquirer system 105, which in turn forwards the authorization response to merchant system 103.

Payment card system 107 includes a location service processor 115. As will be described in detail hereinafter, a cardholder can use a cardholder computer 117 to login to location service processor 115 via network 101 and select real-time transaction information stored in data storage 113 for posting on one or more of a plurality of a social media sites 119. After the cardholder has made the selections, location service processor 115 logs on to social media site 119 and posts the selections.

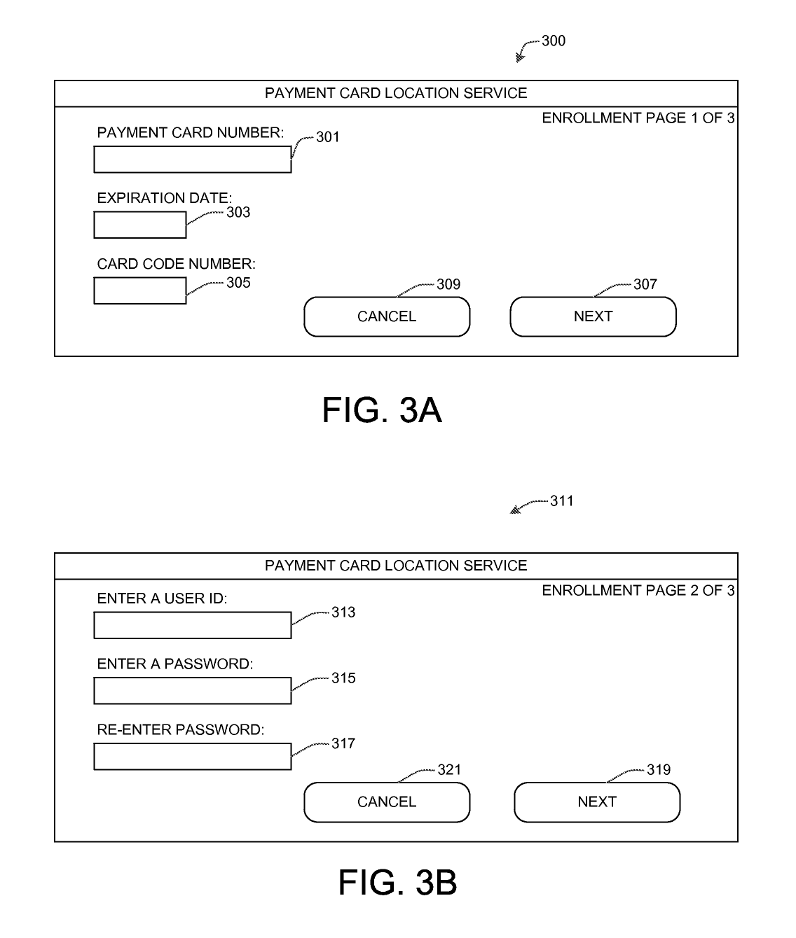

Embodiments of the present disclosure can be implemented as a web-based system in which location service processor 115 transmits to cardholder computer 117 via network 101 webpages. Referring to FIG. 2, a payment card location service sign-in/enrollment webpage is designated generally by the numeral 200, which is displayed on cardholder computer 117. Sign-in/enrollment webpage 200 prompts a cardholder sign in to, or enroll in, the payment card location service. The cardholder signs in to location service processor 115 by entering a user ID in a text entry field 201, a password in a text entry field 203, actuating a SIGN IN button 205. The user ID and password that the cardholder enters in sign-in/enrollment webpage 201 have be previously assigned to or selected by the cardholder in an enrollment process, which the cardholder initiates by actuates an ENROLL button 207.

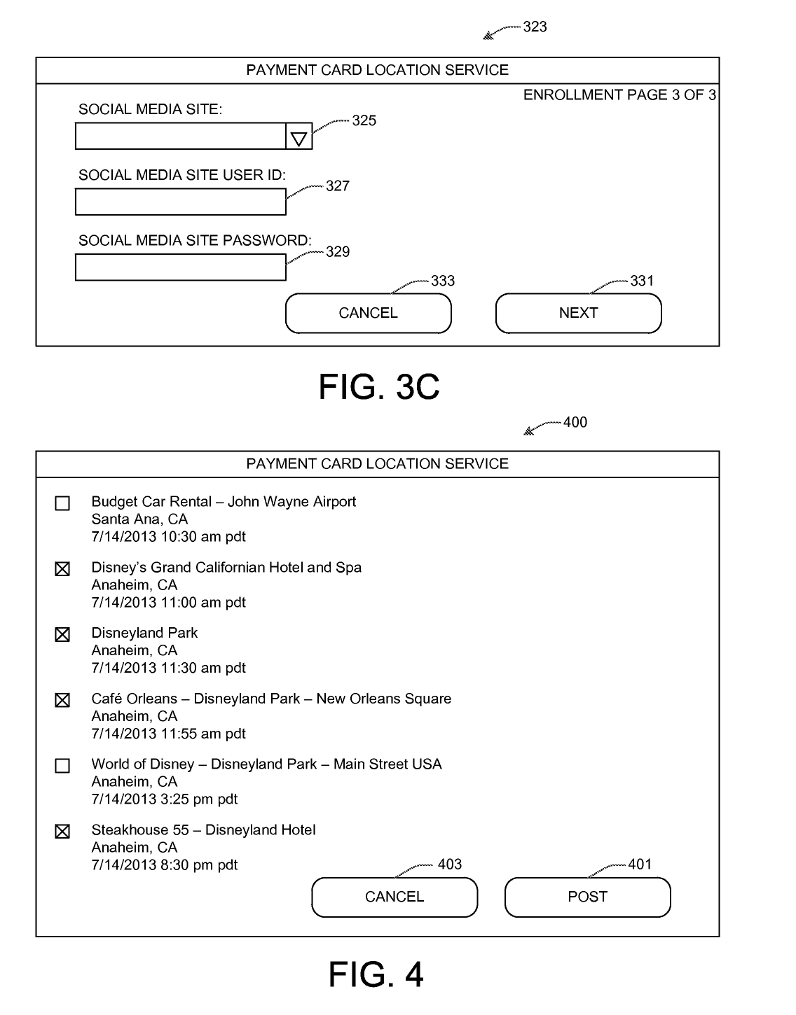

After the cardholder actuates ENROLL button 207, location service processor 115 transmits to cardholder computer 117 a first enrollment webpage 300, as shown in FIG. 3A, which solicits from the cardholder payment card identifying information. The cardholder enters the payment card number in a text entry field 301, the card's expiration date in a text entry field 303, the code number for the card in a text entry field 305, and actuating a NEXT button 307. The code number can be a “card validation code” (“CVC2”), a “card verification value” (“CVV2”), a “card identification number” (“CID”), a “CID” or “unique card code”, or a “card security code” or “CSC”, depending on the type of card. It will be recognized that first enrollment webpage can solicit other identifying and/or security information in addition to, or instead of, the information shown in FIG. 3A. The cardholder can discontinue the enrollment process by actuating a CANCEL button 307.

After the cardholder has actuated NEXT button 309 and location service processor 115 has authenticated the payment card information, location service processor 115 transmits to cardholder computer 117 a second enrollment webpage 311, as shown in FIG. 3B. Second enrollment webpage 311 prompts the cardholder to choose and enter into a text entry field 313 a location service user ID. Second enrollment webpage 311 also prompts the user to choose and enter into a text entry field 315 a password and re-enter the chosen password into a text entry field 317. After entering the required information into text entry fields 313-317, the user can submit the information to location service processor 115 by actuating a NEXT button 319. The cardholder can discontinue the enrollment process by actuating a CANCEL button 319.

After the cardholder has actuated NEXT button 319 and location service processor 115 has determined that the entered information passes any tests of validity, location service processor 117 transmits to cardholder computer 117 a third enrollment webpage 323, as shown in FIG. 3C. The test of validity can include such things as the user ID not consisting of the cardholder's name or email address, the password passing certain strength criteria, and the passwords entered into text entry fields 315 and 317 being identical to each other.

Third enrollment webpage 323 prompts the card holder to select a supported social media site using a drop-down list 325. Examples of social media sites include such sites as Facebook®, MySpace®, and the like. Third enrollment webpage 323 prompts the cardholder to enter his or her social media site user ID into a text entry field 327 and his or her social media site password into a text entry field 329. The cardholder can then submit his or her social media site information to location service processor 115 by actuating a NEXT button 331. If location service processor 115 is able to verify the information entered into third enrollment webpage 323, the cardholder is enrolled in the payment card location service according to embodiments of the present disclosure. The cardholder can discontinue the enrollment process by actuating a CANCEL button 331.

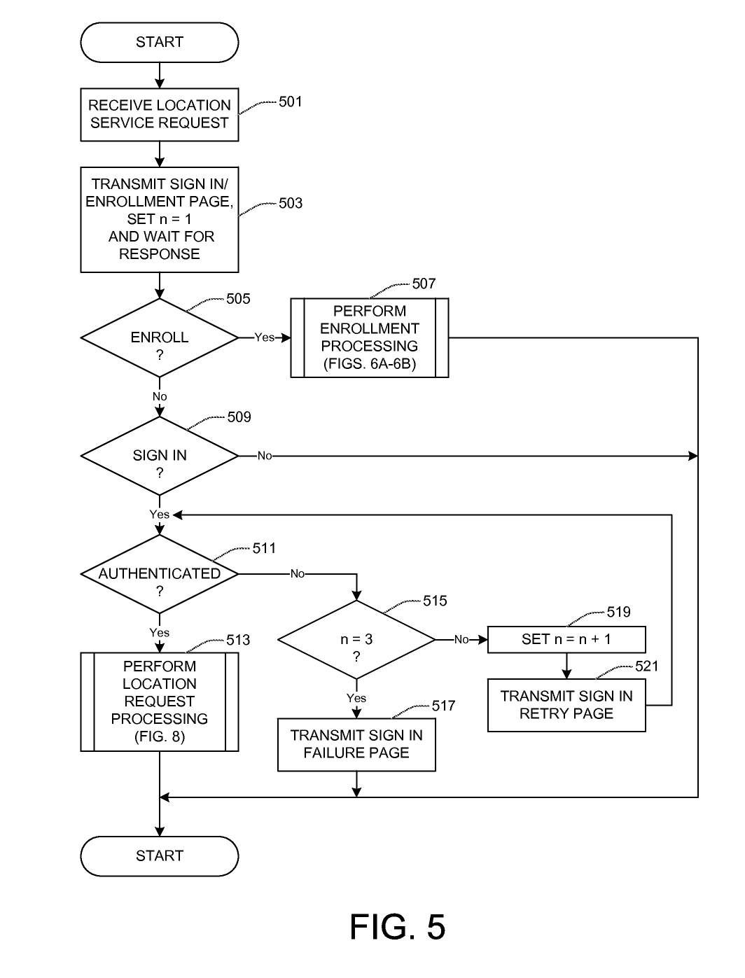

After the cardholder has enrolled in the payment card location service, the cardholder accesses the service by using his or her computer 117 to request sign-in/enrollment webpage 200 entering his or her location service user ID and password into text entry fields 201 and 203, respectively, and actuating SIGN IN button 205. If the login is successful, location service processor 115 retrieves transaction information stored in data storage 113 for the cardholder and transmits to cardholder computer 117 via network 101 a transaction selection webpage 400, as shown in FIG. 4. Transaction selection webpage 400 lists transactions the cardholder has made using his or her payment card. The listed transactions may be those made, for example, over a predefined period preceding the cardholders current login. The transaction information includes a merchant name, location, date and time for the transaction. The cardholder can operate his or her computer to select transactions for posting to his or her registered social media site using check boxes.

Transaction selection webpage 400 depicted in FIG. 4 lists payment card transactions authorized for the cardholder in one day in connection with a family vacation to Disneyland®. As shown in FIG. 4, the cardholder has elected not to have posted to his or her social media site transactions at a car rental facility and a park gift shop. After making his or her selections, the cardholder can instruct location service processor to post the selected transaction information to his or her social medial site by actuating a POST button 401. The cardholder can elect not to have any transactions posted by actuating a CANCEL button 403.

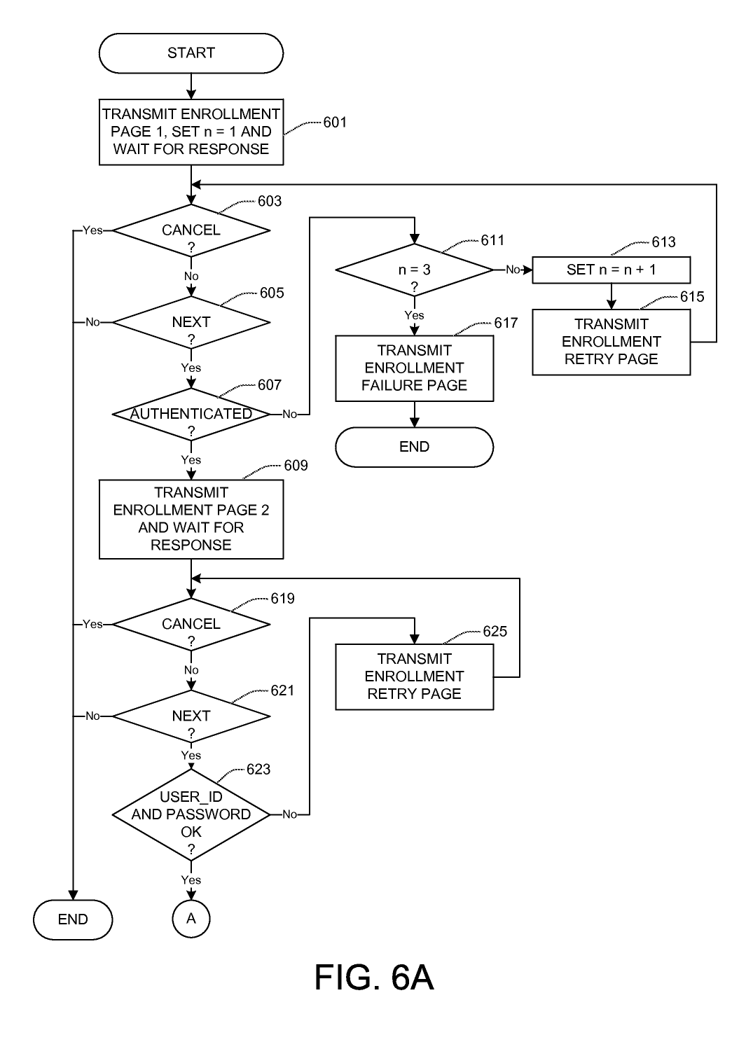

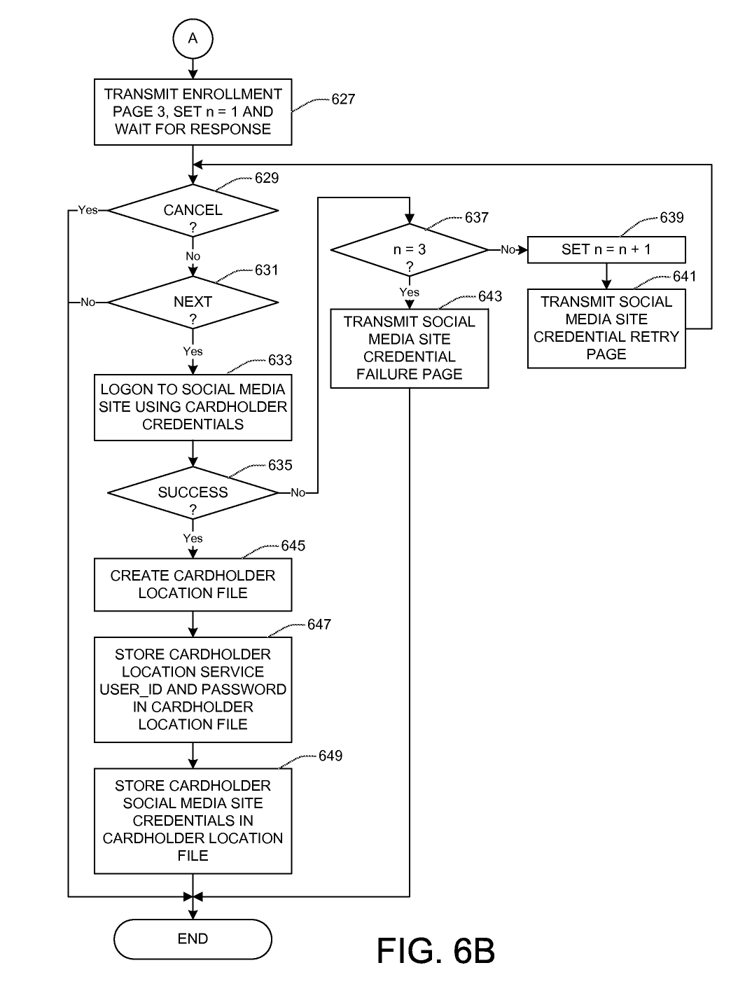

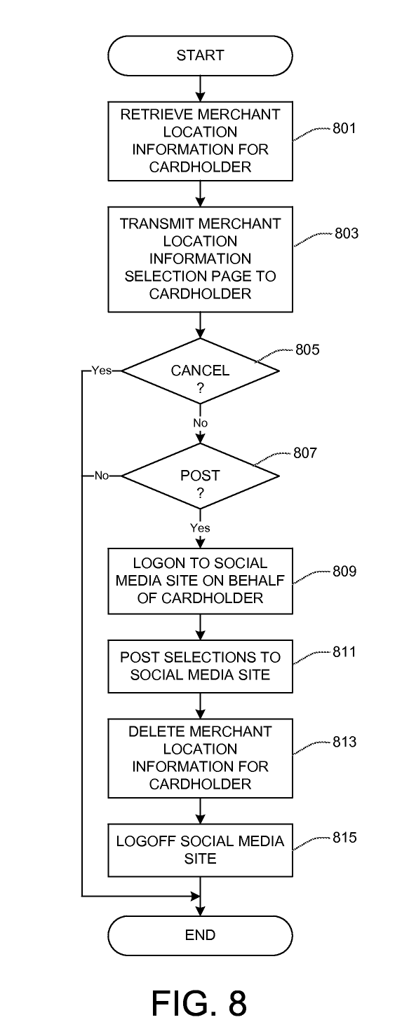

FIG. 5 is a flowchart of an embodiment of payment card location service sign-in and enrollment processing. Location service processor 115 receives a location service request at, block 501, and in response transmits to the requestor a sign in/enrollment page, such as webpage 200, sets a constant n equal to 1, and waits for a response, at block 503. When location service processor 115 receives a response, it determines if the response is ENROLL, at decision block 505. If the response is ENROLL, location service processor 115 performs enrollment processing, as indicated at block 507 and described in detail with reference to FIG. 6A and 6B. If the response is not ENROLL, location service processor 115 determines if the response is SIGN IN, at block 509. If the response is not SIGN IN, processing ends. If the response is SIGN IN, location service processor determines 115, at decision block 511, if the sign-in information (user ID and password) is authenticated. If the sign-in information is authenticated, location service processor 115 performs location request processing, as indicated at block 513 and described in detail with reference to FIG. 8. If the sign-in information is not authenticated, location service processor 115 determines, at decision block 515, if constant n is equal 3, and if not, sets n equal to n plus 1, at block 519, and transmits a sign-in retry page, at block 521. Then processing returns to decision block 511. If, as determined at decision block 515, n is equal to 3, location service processor 115 transmits a sign-in failure page, at block 517, and processing ends.

Referring now to FIGS. 6A and 6B there is shown a flowchart of an embodiment of payment card location service enrollment processing. Location service processor 115 transmits to cardholder computer 117 a first enrollment webpage, sets a constant n equal to 1, and waits for a response, all as indicated at block 401. When location service processor 115 receives a response, it determines if the response is CANCEL, at decision block 603. If the response is cancel, enrollment processing ends. If the response is not CANCEL, location service processor 115 determines if the response is NEXT, at block 605. If the response is not NEXT, enrollment processing ends. If the response is NEXT, location service processor determines, at decision block 607, if the payment card identifying information (card number, expiration date and card code) is authenticated. If the card identifying information is not authenticated, location service processor determines 115, at decision block 611, if constant n is equal 3, and if not, sets n equal to n plus 1, at block 613, and transmits an enrollment retry page, at block 615. Then processing returns to decision block 603. If, as determined at decision block 611, n is equal to 3, location service processor 115 transmits an enrollment failure page, at block 617, and processing ends.

If, as determined at decision block 607, the payment card identifying information is authenticated, location service processor 115 to cardholder computer 117 a second enrollment page, such as webpage 311, and waits for a response, as indicated at block 609. If, as determined at decision block 619, the response is CANCEL, enrollment processing ends. If, as determined at decision block 621, the response is NEXT, location service processor 115 determines, at decision block 623, if the user ID and password entered by the cardholder are OK. If the user ID and password are not OK, location service processor 115 transmits an enrollment retry page, as indicated at block 625, and returns to decision block 619. If the user ID and password are OK, location service processor 115 proceeds to FIG. 6B.

Turning to FIG. 6B, location service processor 115 transmits to cardholder computer 117 a third enrollment page, such as webpage 323, sets a constant n equal to 1, and waits for a response, all as indicated at block 627. If, as determined at decision block 629, the response is CANCEL, enrollment processing ends. If, as determines at decision block 631, the response is NEXT, location service processor 115 attempts to log on to the social media site using the credentials (social media user ID and password) identified in the response, as indicated at block 635, and waits for a response. If, as determined at decision block 635, the logon to the social media site using the cardholder's credentials, location service processor 115 creates a location file for the cardholder in data storage 113, as indicated at block 645, stores the cardholder's location service user ID and password, in the cardholder's location file, as indicated at block 647, and stores the cardholder's social media user ID and password in the cardholder's location file, as indicated at block 649.

Returning to decision block 635, if the attempted login to the social media site using the credentials provided by the cardholder is not successful, location service processor determines 115, at decision block 637, if constant n is equal 3, and if not, sets n equal to n plus 1, at block 639, and transmits social media site credential retry page, at block 641. Then processing returns to decision block 629. If, as determined at decision block 637, n is equal to 3, location service processor 115 transmits a social media site credential failure page, at block 643, and processing ends.

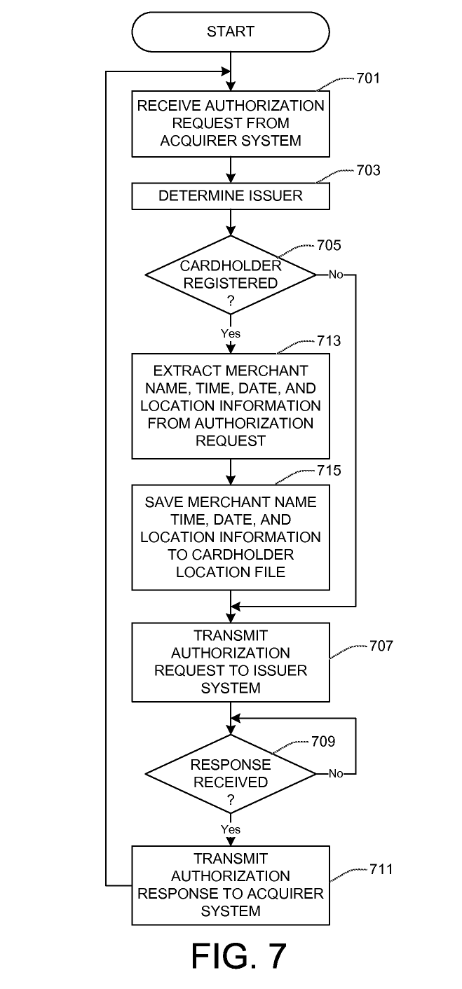

FIG. 7 is a flowchart of an embodiment of payment card location service transaction information extraction processing. Authorization processor 109 receives an authorization request from an acquirer system, as indicated at block 701, and determines the issuer associated with the payment card of the transaction, at block 703. Authorization processor 109 then determines, at decision block 705, if the holder of the payment card is registered for the social media site location posting service. If the cardholder is not registered, authorization processor 109 transmits the authorization request to the issuer system 111, at block 707, and waits for a response. When, as determined at decision block 709, authorization processor 109 receives a response, authorization processor 109 transmits the response to the acquirer system 105, as indicated at block 711. If, as determined at decision block 705, the cardholder is registered for the social media site location posting service, authorization processor 109 extracts the merchant name and location, and transaction time and date from the authorization request, as indicated at block 713. Then, authorization processor 109 saves the extracted information to the cardholder's location posting service file in data storage 103, as indicated at block 715, and proceeds to block 707.

In some embodiments, authorization processor 109 may save information extracted from the authorization request only after authorization processor 109 has received an authorization request approval response message from issuer system 111. For example, authorization processor 109 can save extracted merchant information in a temporary file and then transmit the authorization request to issuer system 111. If authorization processor 109 receives an authorization request approval response message from issuer system 111, authorization processor saves the information in the temporary file to the cardholder location file. If authorization processor 109 receives an authorization request decline or other non-approval response message from issuer system 111, the authorization processor does not save the information in the temporary file to the cardholder location file.

After successful sign-in processing according to FIG. 5, location service processor 115 proceeds to FIG. 8, which is a flowchart of an embodiment of transaction information selection and posting processing. Location service processor 115 retrieves from data storage 103 merchant location information for the cardholder, as indicated at block 801. Then location service processor 115 transmits to cardholder computer 117 a location information selection page, such as webpage 400, and waits for a response. If, as determined at decision block 805, the response is CANCEL, processing ends. If, as determined at decision block 807, the response is POST, location service processor 115 logs on to the social media site on behalf of the cardholder, as indicated at block 809, post the selected transaction items to the social media site, as indicated at block 811, deletes the merchant location information stored in the cardholder's file in the data storage 103, as indicated at block 813, and logs off the social media site, as indicated at block 815.

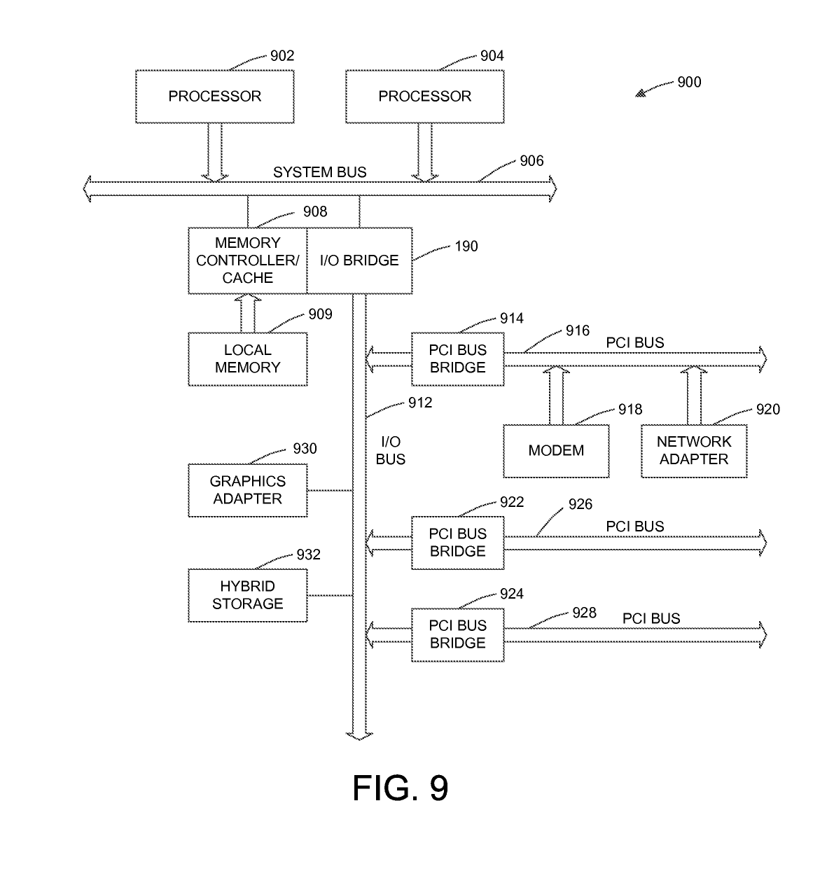

FIG. 9 is a block diagram of a data processing system upon which embodiments of the present disclosure may be implemented. Data processing system 900 may be a symmetric multiprocessor (SMP) system including a plurality of processors 902 and 904 connected to system bus 906. Alternatively, a single processor system may be employed. Also connected to system bus 906 is memory controller/cache 908, which provides an interface to local memory 909. I/O bus bridge 910 is connected to system bus 906 and provides an interface to I/O bus 912. Memory controller/cache 908 and I/O bus bridge 910 may be integrated as depicted.

Peripheral component interconnect (PCI) bus bridge 914 connected to I/O bus 912 provides an interface to PCI local bus 916. A number of modems may be connected to PCI local bus 916. Typical PCI bus implementations will support four PCI expansion slots or add-in connectors. Communications links to networks may be provided through a modem 918 or a network adapter 920 connected to PCI local bus 916 through add-in boards. Additional PCI bus bridges 922 and 924 provide interfaces for additional PCI local buses 926 and 928, respectively, from which additional modems or network adapters may be supported. In this manner, data processing system 900 allows connections to multiple network computers. A memory-mapped graphics adapter 930 and hybrid storage 932 may also be connected to I/O bus 912 as depicted, either directly or indirectly.

Those of ordinary skill in the art will appreciate that the hardware depicted in FIG. 9 may vary. For example, other peripheral devices, such as optical disk drives and the like, also may be used in addition to or in place of the hardware depicted. The depicted example is not meant to imply architectural limitations with respect to the present disclosure.

The data processing system depicted in FIG. 9 may be, for example, an IBM® eServer™ pSeries system, a product of International Business Machines Corporation in Armonk, New York, running the Advanced Interactive Executive (AIX™) operating system or LINUX operating system.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage medium or media having computer readable program code embodied thereon.

Any combination of one or more computer readable storage medium or media may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof, A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions comprising the program code for carrying out aspects of the present disclosure may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable medium produce an article of manufacture including instructions which implement the function/act specified in the foregoing flowchart and/or block diagram block or blocks.

The computer program instructions may also be loaded onto a computer, other programmable data processing apparatus, or other devices to cause a series of operations to be performed on the computer, other programmable apparatus or other devices to produce a computer implemented process such that the instructions which execute on the computer or other programmable apparatus provide processes for implementing the functions/acts specified in the foregoing flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, processes, operations, elements, and/or components, but do not preclude the presence or addition of one or more other features, integers, processes, operations, elements, components, and/or groups thereof.

The corresponding structures, materials, acts, and equivalents of all elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

From the foregoing, it will be apparent to those skilled in the art that systems and methods according to the present disclosure are well adapted to overcome the shortcomings of the prior art. While the present disclosure has been described with reference to the above embodiments, those skilled in the art, given the benefit of the foregoing description, will recognize alternative embodiments. Accordingly, the foregoing description is intended for purposes of illustration and not of limitation.

What is claimed is:

1. A method of posting payment card transaction information to a social media site, comprising:
receiving over a network at a payment card authorization processor a payment card transaction authorization request for a cardholder;
operating the authorization processor to store in a computer storage file associated with the cardholder payment card transaction data included in the authorization request; and,
operating the authorization processor to post over the network at least a portion of the payment card transaction data stored in the file associated with the cardholder to a social media site associated with the cardholder.

2. The method as claimed in claim 1, wherein:
the transaction authorization data includes a merchant name, a date, time and location of the transaction.

3. The method as claimed in claim 1, wherein the posting further includes:
operating a location service processor to logon to the social media site on behalf of the cardholder.

4. The method as claimed in claim 1, the posting further includes:
transmitting over the network to a computer associated with the cardholder a webpage including a list of selectable transaction data items stored in the file associated with the cardholder;
receiving over the network from the computer associated with the cardholder transaction data items selected from the list of selectable transaction data items;
logging in, on behalf of the cardholder, to the social media site over the network; and,
transmitting to the social media site over the network the cardholder transaction data items received from the computer associated with cardholder.

5. The method as claimed in claim 4, further comprising:
deleting from the file associated with the cardholder the transaction data items included in the list transmitted to the computer associated with the cardholder.

6. The method as claimed in claim 1, further comprising:
enrolling the cardholder in a transaction location service.

7. The method as claimed in claim 6, wherein the enrolling further comprises:
verifying an association of a party attempting to enroll with an identified payment card account;
verifying an association of the party attempting to enroll with an identified social media site account; and,
allocating the computer storage file associated with the cardholder to the party verified to be associated with the identified payment card account and the identified social media site account.

8. The method as claimed in claim 1, wherein the authorization processor receives the authorization from an acquiring system and method further comprises:
operating the authorization processor to transmit over the network the authorization request to an issuing system.

9. A social media location posting system, which comprises:
a payment card transaction authorization processor configured to receive over a network a payment card transaction authorization request for a cardholder and store in a computer storage file associated with the cardholder payment card transaction data included in the authorization request; and,
a location service processor configured to post over the network at least a portion the payment card transaction data stored in the file associated with the cardholder to a social media site associated with the cardholder.

10. The system as claimed in claim 9, wherein:
the transaction authorization data includes a merchant name, a date, time and location of the transaction.

11. The system as claimed in claim 9, wherein the location service processor is further configured to:
transmit over the network to a computer associated with the cardholder a webpage including a list of selectable transaction data items stored in the file associated with the cardholder;
receive over the network from the computer associated with the cardholder transaction data items selected from the list of selectable transaction data items;
log in, on behalf of the cardholder, to the social media site over the network; and,
transmit to the social media site over the network the cardholder transaction data items received from the computer associated with cardholder.

12. The system as claimed in claim 9, further wherein the location service processor is further configured to:
enroll the cardholder in a transaction location service.

13. The system as claimed in claim 9, wherein the location service processor is further configured to:
verify an association of a party attempting to enroll with an identified payment card account;
verify an association of the party attempting to enroll with an identified social media site account; and,
allocate the computer storage file associated with the cardholder to the party verified to be associated with the identified payment card account and the identified social media site account.

14. A non-transitory computer-readable storage medium encoded with data and instructions, which when executed by a computing device the instructions causing the computing device to:
receive over a network a payment card transaction authorization request for a cardholder;
store in a computer storage file associated with the cardholder payment card transaction data included in the authorization request; and,
post over the network at least a portion the payment card transaction data stored in the file associated with the cardholder to a social media site associated with the cardholder.

15. The non-transitory computer-readable storage medium as claimed in claim 14, wherein:
the transaction authorization data includes a merchant name, a date, time and location of the transaction.

16. The non-transitory computer-readable storage medium as claimed in claim 14 further encoded with data and instructions, which when executed by the computing device the instructions causing the computing device to:
logon to the social media site on behalf of the cardholder.

17. The non-transitory computer-readable storage medium as claimed in claim 14 further encoded with data and instructions, which when executed by the computing device the instructions causing the computing device to:
transmit over the network to a computer associated with the cardholder a webpage including a list of selectable transaction data items stored in the file associated with the cardholder;
receive over the network from the computer associated with the cardholder transaction data items selected from the list of selectable transaction data items;
log in, on behalf of the cardholder, to the social media site over the network; and,
transmit to the social media site over the network the cardholder transaction data items received from the computer associated with cardholder.

18. The non-transitory computer-readable storage medium as claimed in claim 17 further encoded with data and instructions, which when executed by the computing device the instructions causing the computing device to:
delete from the file associated with the cardholder the transaction data items included in the list transmitted to the computer associated with the cardholder.

19. The non-transitory computer-readable storage medium as claimed in claim 14 further encoded with data and instructions, which when executed by the computing device the instructions causing the computing device to
enroll the cardholder in a transaction location posting service.

20. The non-transitory computer-readable storage medium as claimed in claim 14 further encoded with data and instructions, which when executed by the computing device the instructions causing the computing device to:
verify an association of a party attempting to enroll with an identified payment card account;
verify an association of the party attempting to enroll with an identified social media site account; and,
allocate the computer storage file associated with the cardholder to the party verified to be associated with the identified payment card account and the identified social media site account.
